(19) United States
(12) Patent Application Publication
(10) Pub. No.: US 2025/0157492 A1
(43) Pub. Date: May 15, 2025

(54) METHODS AND SYSTEMS OF FACILITATING MUSIC PRODUCTION AND DISTRIBUTION

(71) Applicants: FACUNDO ROSA, CABA (AR); CESAR MATEOS, CABA (AR)

(72) Inventors: FACUNDO ROSA, CABA (AR); CESAR MATEOS, CABA (AR)

(21) Appl. No.: 18/949,825

(22) Filed: Nov. 15, 2024

Related U.S. Application Data
(60) Provisional application No. 63/599,239, filed on Nov. 15, 2023.

(51) Int. Cl. G11B 27/031; G06F 21/16; G06F 21/62

(52) U.S. Cl. CPC G11B 27/031; G06F 21/16; G06F 21/6209

(57) ABSTRACT

The present disclosure provides a method of facilitating music production. Further, the method may include receiving a first media data from a first user device. Further, the first media data corresponds to a first stage of two or more stages corresponding to the music production. Further, the method may include receiving a second media data from a second user. Further, the method may include validating each of the first media data and the second media data based on a first role data and a second role data respectively. Further, the method may include generating a music data based on each of the first media data and the second media data. Further, the method may include storing the music. Further, the method may include transmitting the music data to each of the first user device and the second user device.

### FIELD OF DISCLOSURE

Generally, the present invention relates to data processing. More specifically, the present invention relates to methods and systems of facilitating music production and distribution.

### BACKGROUND

We are living in the moment of the greatest independent musical production and distribution in history. Thanks to technology, it is currently not necessary to have analog instruments to carry out projects that involve them, and thanks to the internet, all new music can travel the world in one click, spreading across the different social networks and platforms used by artists to connect with their fans and/or audience. This unprecedented access has also transformed the way music is distributed, enabling artists to bypass traditional gatekeepers, such as record labels, and reach listeners directly. Platforms for streaming, digital downloads, and social media now allow independent musicians not only to produce their work but also to distribute it globally with ease. This fosters a growing ecosystem of new artists within all genres, with the phenomenon of hip-hop particularly worth highlighting. This movement is a global trend that, in all its musical manifestations, is characterized by a particularly high number of listeners who, in addition to consuming the work of their preferred artists, choose to undertake their musical productions, either to become professional or purely for fun.

Although today the stage of “showcase,” where the music is exposed to be consumed massively, is widely covered by various distribution alternatives, the stage in which the music exists as a “demo” remains resolved in a very rudimentary way. Instant messaging applications, storage platforms for all types of files, and even emails are some of the methods that artists use to save, manage, and share their demos in the absence of a product specifically designed for this. Furthermore, while distribution platforms excel in delivering finalized tracks to a global audience, they are not designed to support the iterative, collaborative, and creative processes that occur during the earlier stages of music production and demo sharing.

For the artist, the most important stage in the development of their music is not solely the distribution—though it plays a critical role in reaching listeners and monetizing their work—but rather the creative one: when they are writing a rhyme, working on an instrumental prototype, or simply an unfinished project, which is commonly known as a “demo.” This stage requires unique tools that not only support the production of music but also streamline its sharing and feedback loops among collaborators, which are essential for refining ideas before the final mix and mastering.

Therefore, there is a need for improved methods and systems for facilitating both music production and distribution that may overcome one or more of the above-mentioned problems and/or limitations. These systems should provide artists with dedicated resources to enhance the creative process while seamlessly integrating with existing distribution frameworks to optimize the journey from demo to finished product.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of facilitating music production. Further, the method may include receiving, using a communication device, a first media data from a first user device associated with a first user. Further, the first media data corresponds to a first stage of two or more stages corresponding to the music production. Further, the method may include receiving, using the communication device, a second media data from a second user device associated with a second user. Further, the second media data corresponds to a second stage of the two or more stages corresponding to the music production. Further, the method may include receiving, using the communication device, a first role data from the first user device. Further, the first role data indicates a first type of access for the first user device. Further, the method may include receiving, using the communication device, a second role data from the second user device. Further, the second role data indicates a second type of access for the second user device. Further, the method may include validating, using a processing device, each of the first media data and the second media data based on the first role data and the second role data respectively. Further, the method may include generating, using the processing device, a music data based on each of the first media data and the second media data. Further, the generating may be further based on the validating. Further, the method may include storing, using a storage device, the music data in association with one or more of the first user and the second user. Further, the method may include transmitting, using the communication device, the music data to each of the first user device and the second user device.

The present disclosure provides a system for facilitating music production. Further, the system may include a communication device. Further, the communication device may be configured to receive a first media data from a first user device associated with a first user. Further, the first media data corresponds to a first stage of two or more stages corresponding to the music production. Further, the communication device may be configured to receive a second media data from a second user device associated with a second user. Further, the second media data corresponds to a second stage of two or more stages corresponding to the music production. Further, the communication device may be configured to receive a first role data from the first user device. Further, the first role data indicates a first type of access for the first user device. Further, the communication device may be configured to receive a second role data from the second user device. Further, the second role data indicates a second type of access for the second user device. Further, the communication device may be configured to transmit a music data to each of the first user device and the second user device. Further, the system may include a processing device communicatively coupled with the communication device. Further, the processing device may be configured to validate each of the first media data and the second media data based on the first role data and the second role data respectively. Further, the processing device may be configured to generate the music data based on each of the first media data and the second media data. Further, the generating may be further based on the validating. Further, the system may include a storage device communicatively coupled with each of the processing device and the communication device. Further, the storage may be configured to store the music data in association with one or more of the first user and the second user.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3A illustrates a flowchart of a method 300 of facilitating music production, in accordance with some embodiments.

FIG. 3B illustrates a continuation of the flowchart of the method 300 of facilitating music production, in accordance with some embodiments.

FIG. 4 illustrates a flowchart of a method 400 of facilitating music production including modifying, using the processing device 1104, the music data, in accordance with some embodiments.

FIG. 5 illustrates a flowchart of a method 500 of facilitating music production including generating, using the processing device 1104, a feedback data, in accordance with some embodiments.

FIG. 6 illustrates a flowchart of a method 600 of facilitating music production including generating, using the processing device 1104, an access data configured to grant a read only access to one or more of the music data to a listener device, the first media data, and the second media data, in accordance with some embodiments.

FIG. 7 illustrates a flowchart of a method 700 of facilitating music production including generating, using the processing device 1104, one or more of an updated first data, an updated second data, and an updated music data, in accordance with some embodiments.

FIG. 8 illustrates a flowchart of a method 800 of facilitating music production including generating, using the processing device 1104, a third media data corresponding to a third stage of the plurality of stages, in accordance with some embodiments.

FIG. 9 illustrates a flowchart of a method 900 of facilitating music production including analyzing, using the processing device 1104, the API call, in accordance with some embodiments.

FIG. 10 illustrates a flowchart of a method 1000 of facilitating music production including generating, using the processing device, a graphical user interface associated with the music production, in accordance with some embodiments.

FIG. 11 illustrates a block diagram of a system 1100 of facilitating music production, in accordance with some embodiments.

FIG. 12 illustrates a method 1200 of a login/sign-in process of an artist for facilitating music production, in accordance with some embodiments.

FIG. 13 illustrates a method 1300 of a login/sign-in process of a fan for facilitating music production, in accordance with some embodiments.

FIG. 14 illustrates a process diagram of a login process 1400 for facilitating music production, in accordance with some embodiments.

FIG. 15 illustrates a process diagram 1500 of a sign-in process for facilitating music production, in accordance with some embodiments.

FIG. 16 illustrates a process diagram of a retrieving process 1600 of a Chest Information for facilitating music production, in accordance with some embodiments.

FIG. 17 illustrates a process diagram of a process 1700 of playing a music track, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### OVERVIEW

CHEST aims to be the leading and preferred platform for all musical artists so that they can save, manage, and share their musical projects in an agile and secure way from the desktop version and/or its version for iOS and Android. Strategically taking hip hop as a starting point and exploiting its relevance in today's music landscape will allow CHEST to break through critical mass enabling rapid expansion into other genres organically.

“If your music is your treasure, it deserves to have its chest.” CHEST is the first music platform designed exclusively for the instance in which the songs are in the demo stage.

CHEST aims to be the perfect workspace for any musical artist: be it a producer, lyricist, vocalist, mixing engineer, or even a manager, and the user can have all their projects in one place, which is so accessible to them, their team and relatives, as impenetrable to the outside.

CHEST has a mobile version for Apple and Android, as well as a web version to enter from your preferred browser, and we contemplate an eventual development to integrate the software into smart watches, vehicles, and VR, among others.

CHEST is a platform designed by artists, for artists: it was born from the need of a market in evident and exponential growth such as that of music production, whether by amateurs as aspiring professionals or even consolidated professionals. All of these agree on the need to have a workspace where they can centralize all their projects, in any of the many instances before being distributed by traditional dissemination platforms.

CHEST's target audience is artists of all musical genres, although we appreciate a great trend in urban genres such as rap, trap, and reggaeton who are actively developing their music and need a tool to store it safely, as well as make it accessible to your work team at the same time. Through assigned roles and permissions, CHEST is not only intended for artists and producers, but also for other players in the music industry such as sound engineers, managers, representatives, and even those who simply support the artist by listening to their works even before they are released and be professionally distributed.

This innovative platform streamlines the process of sharing and evaluating demos, providing a user-friendly interface, efficient audio processing, and a comprehensive demo management system. The present disclosed system aims to empower musicians by providing them with a platform to showcase their talent and connect with industry professionals.

The present disclosed system is directed to a system that provides synchronized storage and sharing.

The disclosed system may allow users to upload different versions of a particular song, giving access to the people that worked on that particular song, and allowing collaboration with artists and producers. The feature may grant a dynamic and streamlined workflow for all the participants of the elaboration of the music piece, showing the song on every “CHEST” for all the participants since its first upload. These permissions allow each participant, according to their role, to get involved in the project and make any necessary changes.

Furthermore, the present disclosed system may allow the users to share any version of a particular song with third parties. The sharing may be done by a particular “link” or through APIs to connect with different applications, such as social media platforms, music enhancement and preparation, and distribution platforms. The links may be shared through the platforms linked with “CHEST” or by copying the link provided by “CHEST”. It is important to highlight that before the sharing is complete, the user of “CHEST” may be able to preview the mockup and choose which part of the song the user wants to share.

The present disclosed system may allow the user to write the lyrics and link those lyrics to a particular song. Also, as an additional security measure, the present disclosed system may apply a silent watermark only hearable with CHEST's software on any uploaded song, so it may be possible to securely detect any leaker of a song.

The list of features may be for enumerative purposes only and under no circumstances will it attempt to be an exhaustive list, more features may be added to the present disclosed system.

Further, in the current version, the features of the present disclosed system may include Roles & Permissions, Version management, Temporary links and Snippet generator.

Further, the features in the development of the present disclosed system may include: a) The Box: Following the idea that CHEST should be a treasure chest where music is centralized in all its stages, it's natural to have an internal text editor where the artist can leave all their rhymes and ideas, so the artist may quickly assign them to both new and existing projects. The word processor may open the doors to the “Live Collab” function, a tool designed to streamline the workflow that takes place in the studio between producers and artists; b) Record in CHEST: Using the same reasoning as in “The Box”, it is essential to eventually integrate an internal voice note recorder, which may allow the artist to convert a melody they have just immortalized into the first version of a new demo; c) Silent watermarks: The same way Hollywood actors get their scripts with a watermark with their name so they are more likely to protect the privacy of the script because they would be publicly responsible for its leak, CHEST may print silent watermarks as an ID in selected tracks, that may only be hearable through the Chest software, so even if the song sounds the same, the artist and its team may find out who leaked the project; d) AutoSync: Automatic Sync between CHEST and a chosen folder from a PC, permanently updated, so even in a scenario where the PC is damaged in any way, its content may stay protected in servers and accessible through CHEST; e) “CHESTocks”: Crowdfunding platform that may allow “qualified investors” to fund musicians and get a percentage of the project in return, managing to get back or even multiply their investment if the song takes off, or simply providing support in a worst-case scenario where the song does not work out. “Qualified investors” means any person who duly registers in the present disclosed system and gets approved by CHEST, provided CHEST makes reasonable efforts to complete a KYC (“Know Your Client”) process; f) “CHESTmometer”: Feature that may provide musicians with the necessary information to decide which song/s would be the most appropriate to release, considering CHEST internal information as well as social network data and the current music trends; and g) “CHEST Connect”: An improved version of what the current version already enables; a way to connect artists and producers with each other, either organically or in exchange for money, so they may collaborate and bring new projects together.

As stated before, the present disclosed system relates to a music platform and, more particularly and specifically, to a system for providing synchronized storage and sharing of demo submissions by aspiring artists from its inception until its publication, or even if they are never released.

The present disclosed system may be operated on https://chestmusic.com/and, from there, the system may prompt the user to verify the landing page whose protagonist is to offer a quick understanding of what CHEST is about as a project, its operation, its spirit, aesthetics, and vision, reflected in the images that dominate the screen, as well as the institutional video that in a few minutes describes the current product from end to end.

In the upper margin, the present disclosed system may have the brand's logotype on the far left and a series of sections on the right that may allow the user to navigate the landing page more quickly:

Further, the series of sections may include: a) the project: a section where the previously mentioned video may reside as well as a brief CHEST manifesto; b) the team: a section where the members of the team behind the project may appear as well as the role they play; c) open chest: the section may open the application of CHEST.

Through the “open chest” button, the system may transfer the user from the landing to https://app.chestmusic.com/, where the system may prompt the user to register through their google account or using the native CHEST system and enter the following data: a) Name: Full name of the person or organization behind the artist(s); b) Email; c) Password: Create a secure and original password for the user's CHEST account.

From this page, the system may redirect the user to a new page to select the type of account that the user may want. The account types may include “ARTIST” and “FAN”.

Once the election has been made, the present disclosed system may redirect the user to the next page, where it may be required to configure the new user of CHEST, having to complete the following: a) Username: The username may be a unique and unrepeatable name that each user has, and that CHEST may use as an ID. If the chosen username may be already in use, the person may be asked to choose another one. The username begins with the “@” symbol, may be unique to the account, and appears in the user's profile URL. The username may be seen when roles are assigned, or in any case where it may be essential not to confuse two or more artists who share the same name. Other users may search for a person by its username. The username must be more than 4 characters and up to 15 characters or less, it may contain only letters, numbers, and underscores; no spaces allowed; b) Artist name: The artist's name may be a personal identifier in CHEST and may be independent of the username. Unlike the username, the artist's name may be not necessarily unique to the account. It may be something funny, a business name, or a real name, and it may appear next to the username. The artist's name may be updated twice in a 30-day period; c) PIN code: PIN Code may be optional but recommended. It may be a 4-digit code that works like the desktop version of fingerprint or facial recognition that mobile devices currently use as a quick, but effective, identification measure. The user may modify it later by entering the profile page, and then the “SECURITY” section; d) Terms & Conditions: Check Box where the user may affirm that the Terms and Conditions of CHEST have been read and accepted so that the “Create CHEST” button may be unlocked and may be clicked.

Once the account is created, the present disclosed system may redirect the user to the homepage of the CHEST application.

If the user already has an account, entering https://app.chestmusic.com/may allow the present disclosed system to prompt the user to log in to its account. The present disclosed system may show the user the title “OPEN YOUR CHEST”, whereby logging in with google or the native CHEST system, the present disclosed system may allow the user to enter the platform. In the case of entering the password incorrectly on three consecutive occasions, in addition to asking the user if the password has been forgotten, the present disclosed system may send an electronic mail to the email assigned to the account that was intended to be entered to notify that there was an access attempt.

Once the user is logged in, the present disclosed system may redirect the user to the home page of the CHEST application.

Once in the home page of CHEST application, the main screen may be distributed between: a) Drop it like it's hot: the present disclosed system may allow the user to upload an audio file either by dragging it or using the “choose from your files” button, which may take them to the user's files; b) Information bar+Searcher: Here the present disclosed system may prompt the user to find information such as the number of tracks uploaded, the number of megabytes and or time used and available and their representation as a percentage, the possibility of increasing the plan if the user needs more storage, and a search engine to access more quickly the song the user may be looking for; c) Track list: If there may be nothing uploaded it may appear as “Nothing here”, otherwise the present disclosed system may prompt the user to find the music library detailed by title which is name of the song, album which is name of the album to which it belongs, if applicable, version which is the version may be a way to distinguish between multiple versions of the same track, date which is the date in which the track has been uploaded and, duration which is the duration may be the length of a particular version of the song.

On the far right of each song the present disclosed system may show the user two buttons: a) Share, share button may allow the present disclosed system to give the user the possibility to share the specific song; b) Individual actions, when the user hover over this button, the present disclosed system may show 4 sub-options: i) View detail, view button may allow the present disclosed system to show the track details; ii) Add, add button may allow the present disclosed system to allow the user to add a new version of this same track; iii) Edit, edit button may prompt the present disclosed system to allow the user to edit the details of a particular track; and iv) Delete, delete button may prompt the present disclosed system to allow the user to erase a particular track.

When using the action to upload a track, the present disclosed system may provide the user with 2 ways to accomplish it. The present disclosed system may allow the user to upload an audio file either by dragging it or using the “choose from your files” button, which may take the user to the user's files. Having dragged a file into the “Drop it like it's hot” field, or selecting one with the “Choose from your files” button, a window with the title “NAME YOUR TREASURE” may open, and while we observe a progress round bar showing the percentage of file uploaded and its eventual successful completion, or error notification, the user may be prompted to fill out the following fields: a) Track name, track name may be a mandatory field to give a title, even provisional, to the production; b) Version, version field may be an optional field so that the user may classify the different versions of the model. It may be a custom format, or the default CHEST format (1.0, 1.1, 1.2, 2.0, etc.); c) Album, album field may be an optional field, which when left empty means that the demo may be a single. If the user starts writing in the field, a list may be displayed with the albums already existing in the user's chest so the user may add the track to it, and if it may be a new title, create a self-titled album; d) User's role, role field may be a drop-down list where the user must define its role in the production, whether artist or producer; e) Cover: cover field may be a field that, by default, offers to choose between generic CHEST designs, but by hovering over the image the user may also change it by choosing between the device files.

Having completed the fields and clicking on “CONTINUE”, the present disclosed system the may prompt user to reach the next point, where the present disclosed system may provide the user with the possibility to give roles and permissions to third parties and collaborators.

The role system may be designed on the fact that within the music industry, there are different actors who get involved with the development of productions in various ways, which may lead CHEST to build an ecosystem where these roles are defined in a way that also their respective permissions and accesses are.

In the language of the current music industry, “ARTIST” may be understood as the vocalist (and sometimes, but not always, lyricist of a song) and “PRODUCER” as the person in charge of the recording, and/or instrumental, and/or mix, etc. These terms are increasingly being reviewed since it makes no sense to not classify the Producer as an ‘artist’, but at the same time the term ‘vocalist’ may be not very familiar to those who make urban music, especially rap, which usually has little of melodies or singing.

The following are the roles that the present disclosed system currently recognizes: a) Artist/Producer: The main CHEST user, uploads, stores, and shares its music with whoever the user wants and, in any way, possible; b) Feat: The so-called “featuring” may be when an artist is invited to another's project, so the artist who may be assigned this permission, although he may listen to it, cannot share it in any way; c) Listener: For every artist who may be using CHEST, there are loyal followers and listeners that are eager to hear their music before anyone else. As long as the listener may be enabled by any owner of the track, the listener may listen to it but never share it.

The permission may be seen on the “DETAILS” page of each particular song. On the home page, the present disclosed system may allow the user to enter the “DETAILS” page with the individual actions button to “View Details”, as explained herein. On the “DETAILS” page, the present disclosed system may allow the user to see if a shared link has been generated, and all the plays that every link and permitted person has done with that particular song.

Once the roles have been assigned, the present disclosed system may prompt the user to share its treasure, that is, the recently uploaded music track. The present disclosed system may allow the user to establish if the user wants a play limit on the link or to have unlimited plays. Once this is done, the page may generate a link to be shared.

Further, there are buttons prompting the generation of a link and other buttons to post a part of the song in the user's social media feeds.

Finally, the present disclosed system may allow the user to hear every song either from the home page or the “DETAILS” page for each song. The present disclosed system may require the user to double-click, and a music player may emerge on the bottom of the screen, showing: a) The name of the song; b) The participants of the song; c) Media buttons to play/stop the music, change to the previous/next song, and to use the “random play” and “repeat” mode; d) A time bar showing the total length of the song. The bar shows a color progressing as the song advances in time; e) a volume bar, which may be prompted to decrease/increase the volume of the media player.

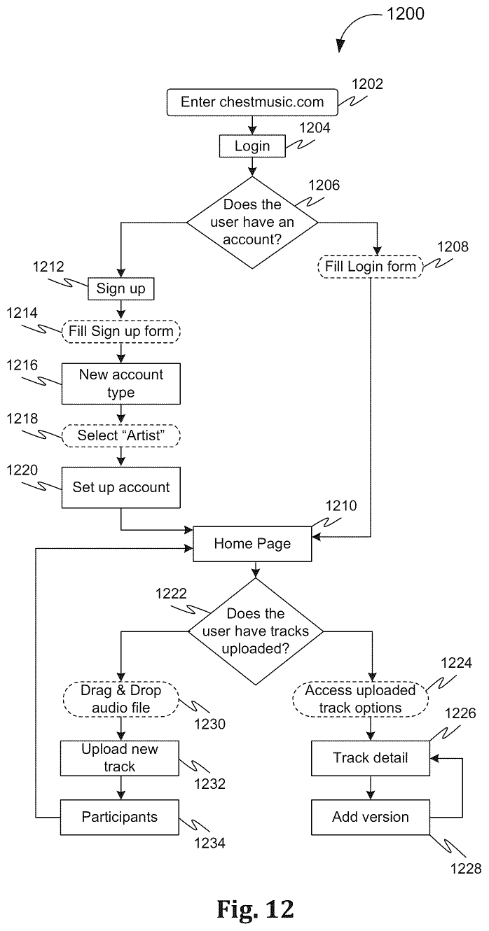

FIG. 12 illustrates a method 1200 of a login/sign-in process of an artist for facilitating music production, in accordance with some embodiments.

Accordingly, the method 1200 may include a step 1202 at which a user accesses the system using a URL. Subsequently, the method 1200 may include a step 1204 of displaying a login screen to the user. Subsequently, an evaluation 1206 is performed associated with Does the user have an account? If the result of the evaluation 1206 is yes, then subsequently, the method 1200 includes execution of a step 1208 of receiving the login information using a login form. Subsequently, the method 1200 includes a step of 1210 of displaying the home page to the user based on successful verification of the login information. If the result of the evaluation 1206 is no, then subsequently, the method 1200 includes step 1212 of displaying a sign-up screen. Subsequently, the method 1200 execution of a step 1214 of receiving signup information based on displaying a sign-up form. Subsequently, the method 1200 includes a step 1216 of receiving an account type data from the user, for example selecting “Artist” option 1218. Subsequently, the method 1200 includes a step 1220 of setting up of account based on the signup information. Subsequently, the method 1200 includes a step 1210 of displaying the home page to the user based on successful signup. Subsequently, an evaluation 1222 is performed of do the user has tracks uploaded? If the result of the evaluation 1222 is yes, then subsequently, the method 1200 includes execution of a step 1224 of accessing uploaded track options. Further, the method 1200 includes a step 1226 of displaying the track details. Further, the method 1228 includes a step 1228 of displaying an option to add a version, and then subsequently, the method 1200 includes a step 1226 of displaying the track details. If the result of the evaluation 1222 is no, then subsequently, the method 1200 includes a step of 1230 of displaying the option to drag and drop audio file. Further, the method 1200 includes a step 1232 of receiving a track data based on upload new track option. Further, the method 1200 may include a step 1234 of receiving a participant data. Subsequently, the method 1200 may include a step 1210 of displaying the home page.

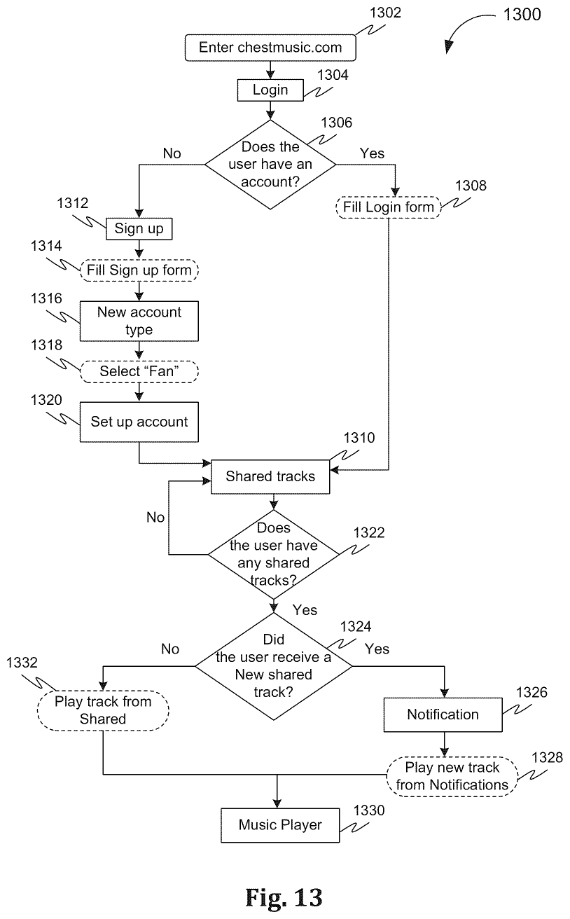

FIG. 13 illustrates a method 1300 of a login/sign in process of a fan for facilitating music production, in accordance with some embodiments.

Accordingly, the method 1300 may include a step 1302 at which a user accesses the system using a URL. Subsequently, the method 1300 may include a step 1304 of displaying a login screen to the user. Subsequently, an evaluation 1306 is performed associated with Does the user have an account? If the result of the evaluation 1306 is yes, then subsequently, the method 1300 includes execution of a step 1308 of receiving the login information using a login form. Subsequently, the method 1300 includes a step of 1310 of displaying the home page to the user based on successful verification of the login information. If the result of the evaluation 1306 is no, then subsequently, the method 1300 includes step 1312 of displaying a sign-up screen. Subsequently, the method 1300 execution of a step 1314 of receiving signup information based on displaying a sign-up form. Subsequently, the method 1300 includes a step 1316 of receiving an account type data from the user, for example selecting “Fan” option 1318. Subsequently, the method 1300 includes a step 1320 of setting up of account based on the signup information. Subsequently, the method 1300 includes a step 1310 of displaying the shared tracks to the user based on successful signup. Subsequently, an evaluation 1322 is performed of does the user has any shared tracks? If the result of the evaluation 1322 is yes, then subsequently, an evaluation 1324 is performed if the user received a new shared track? If the result of the evaluation 1324 is yes, then subsequently, the method 1300 includes execution of a step 1326 of displaying a notification. Further, the method 1300 includes a step 1328 of receiving a command to play new track from notification. Further, the method 1300 includes a step 1330 of playing the new track using the music player. If the result of the evaluation 1324 is no, then subsequently, the method 1300 includes execution of a step 1332 of receiving a command to play track from shared. Further, the method 1300 includes a step 1330 of playing the new track using the music player. If the result of the evaluation 1322 is no, then subsequently, the method 1300 includes execution of a step 1310 of displaying the shared tracks window.

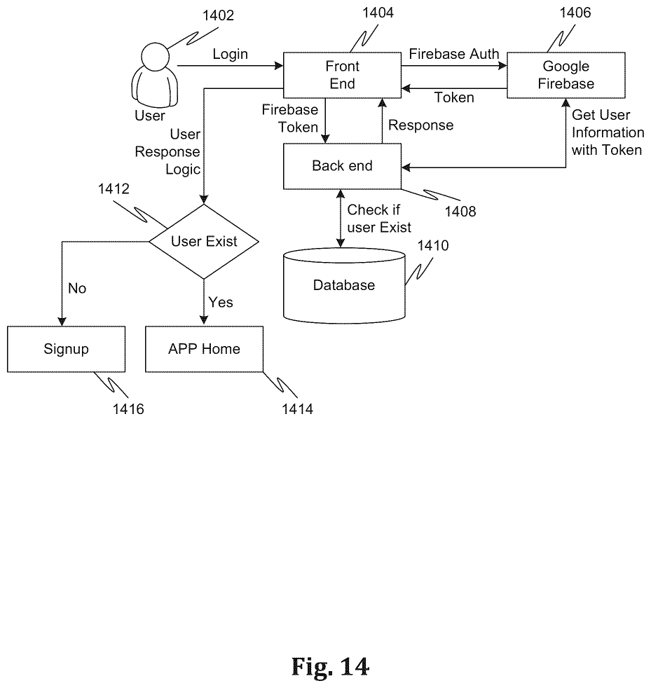

FIG. 14 illustrates a process diagram of a login process 1400 for facilitating music production, in accordance with some embodiments.

Accordingly, the login process 1400 includes a user 1402 interacting with the front end 1404 by the “login” page. Further, the front end 1404 may communicate with google firebase 1406 by a firebase authentication, and then, google firebase 1406 may return a token.

Further, the front end 1404 may communicate with the back end 1408 through the token generated by google firebase 1406. Further, the back end 1408 may communicate with the google firebase 1406 through the token to obtain the user information. Further, the back end 1408 may verify with the database 1410 if the user exists and then respond to the front end 1404 with a user response logic.

Further, the login process 1400 may include an evaluation 1412 of if the user exists, if the result of the evaluation 1412 is yes, then subsequently, the front end 1404 authorizes the user 1402 to enter the application home 1414. If the result of the evaluation 1412 is no, then subsequently, the front end 1404 may redirect the user to the signup page 1416.

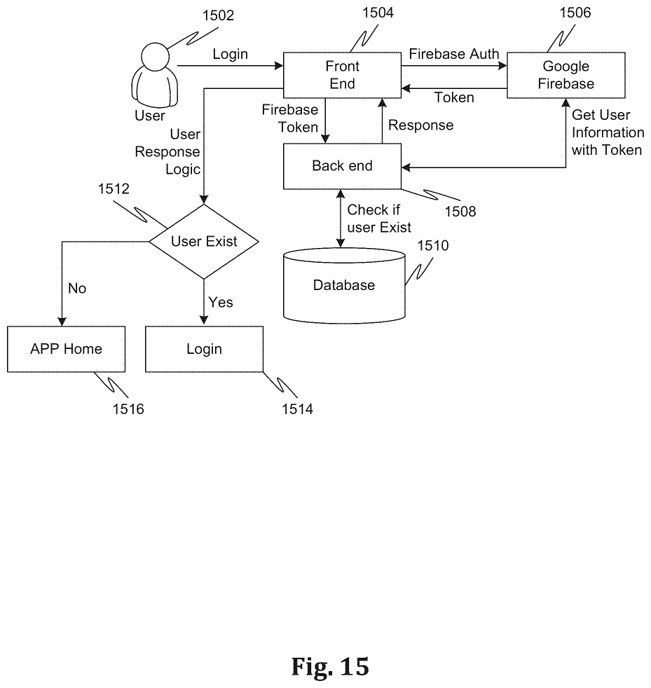

FIG. 15 illustrates a process diagram 1500 of a sign-in process for facilitating music production, in accordance with some embodiments.

Accordingly, the sign-in process 1500 includes a user 1502 interacting with the front end 1502 by the “signup” page. Further, the front end 1504 may communicate with a google firebase 1506 by a firebase authentication, and then, google firebase 1506 may return a token.

Further, the front end 1504 may communicate with the back end 1508 through the token generated by google firebase 1506. Further, the back end 1508 may communicate with the google firebase 1506 through the token to obtain the user information. Further, the back end 1508 may verify with the database 1510 if the user 1502 exists and then respond to the front end 1504 with a user response logic.

Further, the sign-in process 1500 may include an evaluation 1512 of if the user exists. Further, if the result of the evaluation 1512 is yes, then subsequently, the front end 1504 may redirect the user to the login page 1514. If the result of the evaluation 1512 is no, then subsequently, the front end 1504 authorizes and may redirect the user 1502 to the application home page 1516.

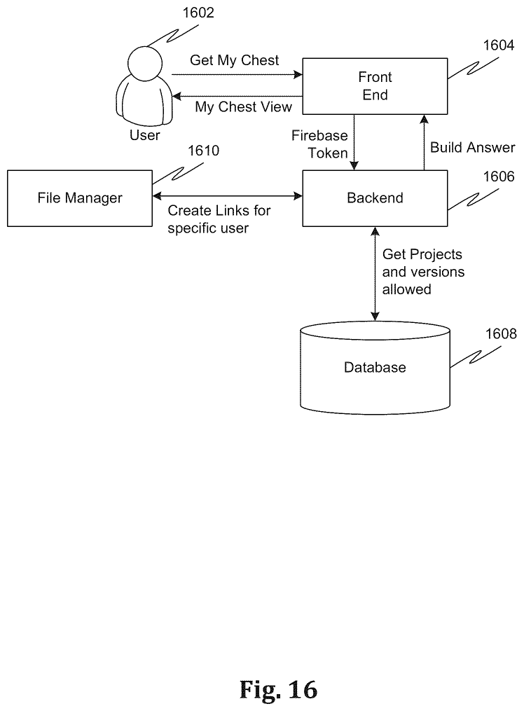

FIG. 16 illustrates a process diagram of a retrieving process 1600 of a Chest Information for facilitating music production, in accordance with some embodiments.

Accordingly, the retrieving process 1600 may include the user 1602 interacting with the front end 1604 by the “get my chest information” option. Further, the front end 1604 may communicate with the back end 1606 through the same token as the “login” page.

Further, the back end 1606 may get projects and versions allowed and then bring together all the projects in which the user appears as a participant plus those to which the user has access through third-party actions from a database 1608.

Further, the back end 1606 may create links for the specific user through the file manager 1610 and build the answer with metadata, thumbnails, and links with the music. Further, the front end 1604 may provide the user with “my chest view”.

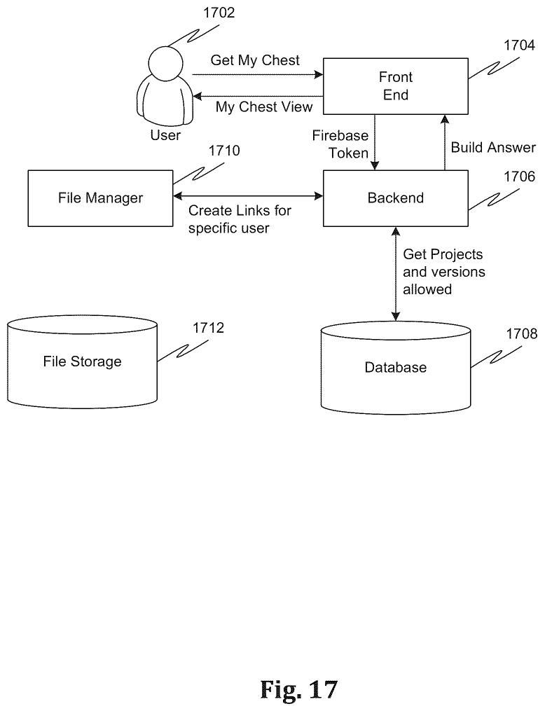

FIG. 17 illustrates a process diagram of a process 1700 of playing a music track, in accordance with some embodiments.

Accordingly, the process 1700 may include a user 1702 interacting with the front end 1704 through the “play” function of the application. Further, the front end 1704 may communicate with a back end 1706 through the same token as the “login” page.

Further, the back end 1706 may verify with the database 1708 the permissions of the user 1702. Furthermore, the back end 1706 may update the “play” function information throughout the database 1708. Further, the back end 1706 may provide a link for the user 1702 to play the music with the file manager 1710.

Further, the back end 1706 may provide the link for playing the music track to the front end 1704, allowing the user 1702 to interact with the front end 1704 to consume the link and play the music stored within the system in a file storage 1712 and managed by the file manager 1710.

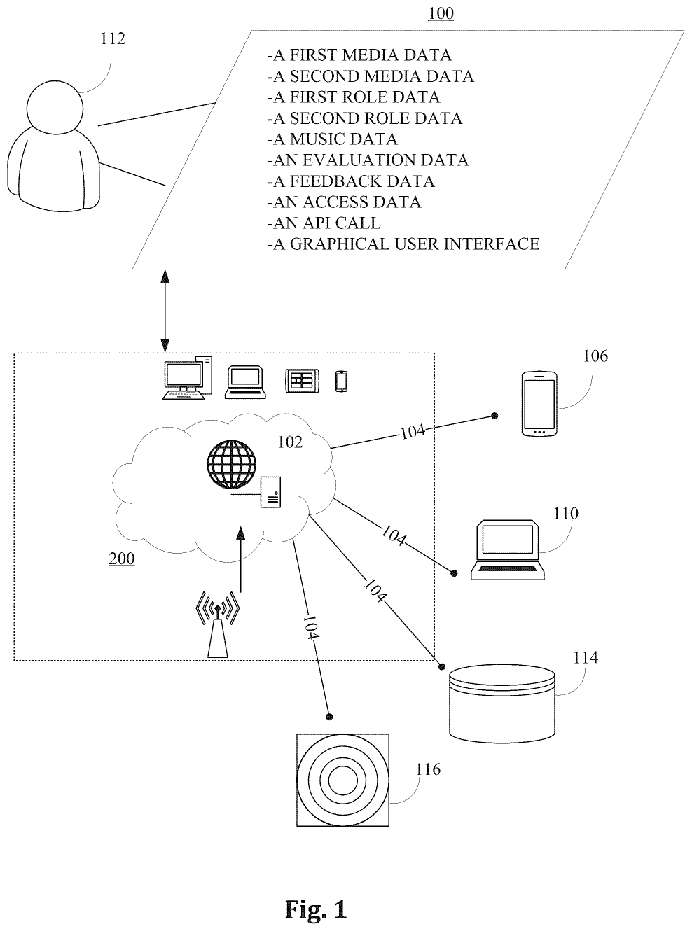

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web-based software application may be embodied as, for example, but not be limited to, a website, a web application, a desktop application, and a mobile application compatible with a computing device 200.

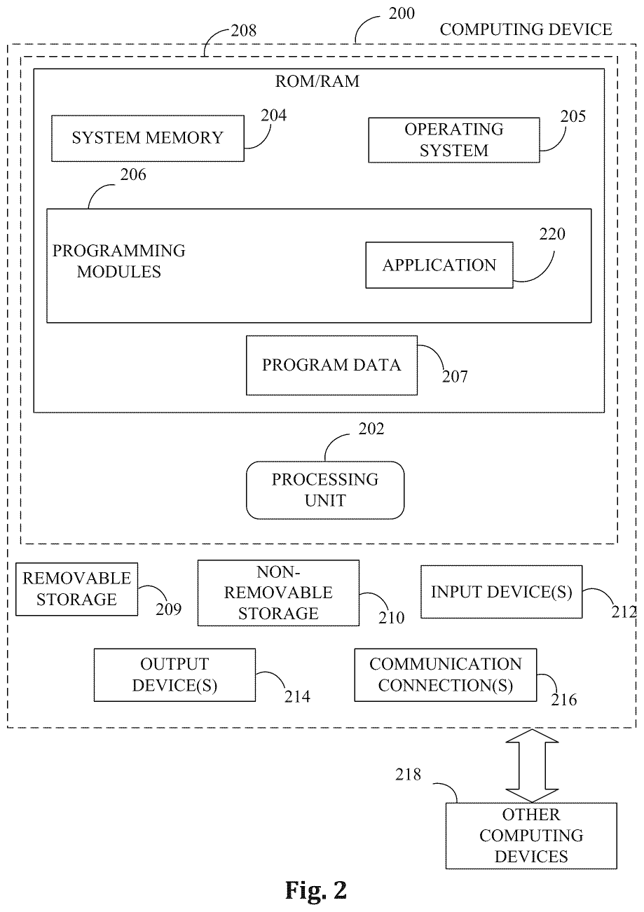

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable, and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include but is not limited to, RAM, ROM, electrically erasable read-only memory (EEPROM), flash memory or other memory technology, CD-ROM, digital versatile disks (DVD), or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

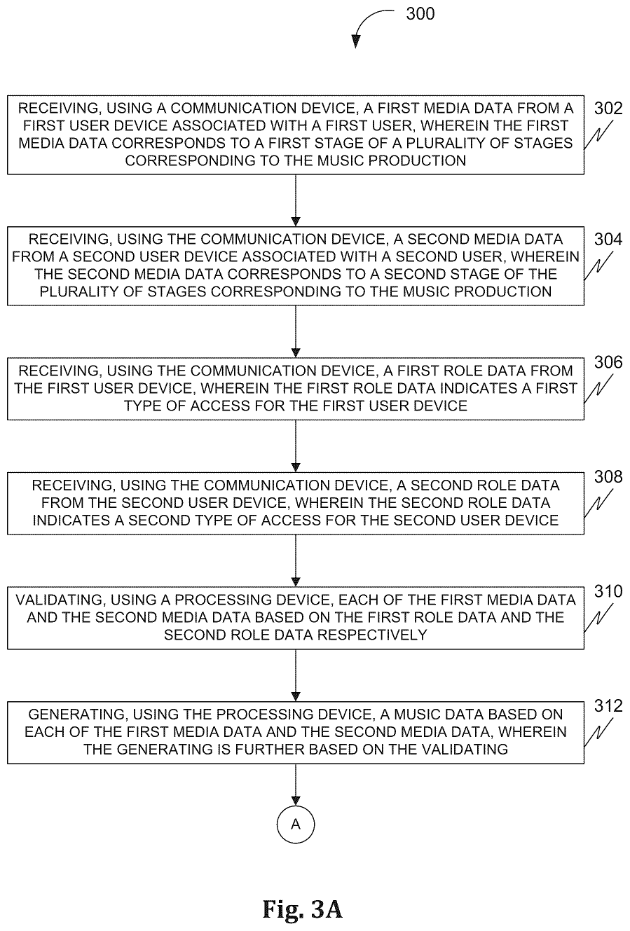

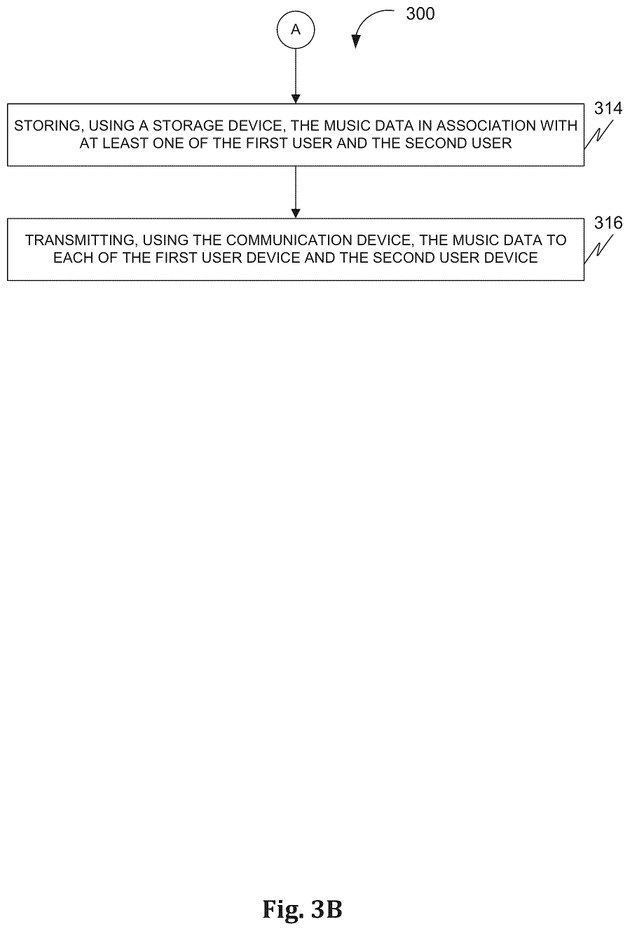

FIG. 3A and FIG. 3B illustrate a flowchart of a method 300 of facilitating music production, in accordance with some embodiments.

In some embodiments, the facilitation of the music production includes managing a musical project from one or more of a desktop device and a mobile device. In some embodiments, the mobile device includes one or more of an android device and an iOS device. In some embodiments, facilitation of the music production includes one or more of a sharing and an evaluation of a demo data.

Accordingly, the method 300 may include a step 302 of receiving, using a communication device 1102, a first media data from a first user device associated with a first user.

In some embodiments, the first media data includes a first musical element of the music data. In some embodiments, the first musical element includes one or more of a lyrical elements, an instrumental element, and a rhythmic element.

In some embodiments, the first user device includes one or more of a desktop device, a smartphone, a smart watch, a smart vehicle, and a VR device. In some embodiments, the first user generated the first media data.

Further, the first media data corresponds to a first stage of two or more stages corresponding to the music production. Further, the method 300 may include a step 304 of receiving, using the communication device 1102, a second media data from a second user device associated with a second user.

In some embodiments, the second media data includes a second musical element of the music data. In some embodiments, the second musical element includes one or more of a lyrical elements, an instrumental element, and a rhythmic element.

In some embodiments, the second user device includes one or more of a desktop device, a smartphone, a smart watch, a smart vehicle, and a VR device. In some embodiments, the second user generated the second media data.

Further, the second media data corresponds to a second stage of the two or more stages corresponding to the music production. Further, the method 300 may include a step 306 of receiving, using the communication device 1102, a first role data from the first user device. Further, the first role data indicates a first type of access for the first user device.

In some embodiments, the first role data includes one or more of an artist data, a producer data, and a featuring data. In some embodiments, the first type of access includes one or more of a read access, a write access, and a read-write access.

Further, the method 300 may include a step 308 of receiving, using the communication device 1102, a second role data from the second user device. Further, the second role data indicates a second type of access for the second user device.

In some embodiments, the second role data includes one or more of an artist data, a producer data, and a featuring data. In some embodiments, the second type of access includes one or more of a read access, a write access, and a read-write access.

Further, the method 300 may include a step 310 of validating, using a processing device 1104, each of the first media data and the second media data based on the first role data and the second role data respectively. Further, the method 300 may include a step 312 of generating, using the processing device 1104, a music data based on each of the first media data and the second media data. Further, the generating may be further based on the validating. Further, the method 300 may include a step 314 of storing, using a storage device 1106, the music data in association with one or more of the first user and the second user.

In some embodiments, the storage device 1106 includes a non-volatile memory. In some embodiments, the storage device 1106 includes of a cloud infrastructure.

Further, the method 300 may include a step 316 of transmitting, using the communication device 1102, the music data to each of the first user device and the second user device.

In some embodiments, the music data may be stored in a hierarchical data structure comprising of two or more music data. Further, each of the two or more music data includes an index data which may be configured to allow accessing of a corresponding music data within the hierarchical data structure.

In some embodiments, the receiving of one or more of the first media data and the second media data may be facilitated by a musical instrument digital interface (MIDI) device. In some embodiments, the MIDI device includes a hardware which may be configured to generate and transmit a MIDI data to a MIDI-enabled device.

In some embodiments, the method 300 may further include receiving, using the communication device 1102, a digital currency data from an investor device. Further, the digital currency data corresponds to a fixed amount of a physical currency.

Further, in some embodiments, the method 300 further may include analyzing, using the processing device 1104, the music data. Further, in some embodiments, the method 300 further may include generating, using the processing device 1104, a snippet data based on the analyzing. Further, the snippet data may be a subset of the music data. Further, in some embodiments, the method 300 may include transmitting, using the communication device 1102, the snippet data to one or more of the first user device and the second user device.

Further, in some embodiments, the method 300 may include receiving, using the communication device 1102, a textual data from one or more of the first user device and the second user device. Further, in some embodiments, the method 300 further may include storing, using the storage device 1106, the textual data. Further, the generation of the music data may be further based on the textual data.

In some embodiments, the storing of one or more of the first media data, the second media data, and the music data may be based on a blockchain.

Further, in some embodiments, the method 300 further may include analyzing, using the processing device 1104, the first media data. Further, in some embodiments, the method 300 may include generating, using a generative AI module, one or more recommended media data based on the analyzing. Further, in some embodiments, the method 300 may include transmitting, using the communication device 1102, the one or more recommended media data to the second user device. Further, the one or more recommended media data may include the second media data.

Further, in some embodiments, the method 300 may include analyzing, using the processing device 1104, each of the first media data and the second media data using a multi-modal AI module. Further, in some embodiments, the method 300 may include generating, using the processing device 1104, one or more recommendation data based on the analyzing. Further, in some embodiments, the method 300 may include transmitting, using the communication device 1102 the one or more recommendation data to one or more of the first user device and the second user device.

Further, in some embodiments, the method 300 may include analyzing, using the processing device 1104, each of the first media data, the second media data and the music data using a multi-modal AI module. Further, in some embodiments, the method 300 may include generating, using the processing device 1104, one or more of a modified first media data, a modified second media data and a modified music data based on the analyzing. Further, in some embodiments, the method 300 may include transmitting, using the communication device 1102, one or more of the modified first media data, the modified second media data and the modified music data to one or more of the first user device and the second user device.

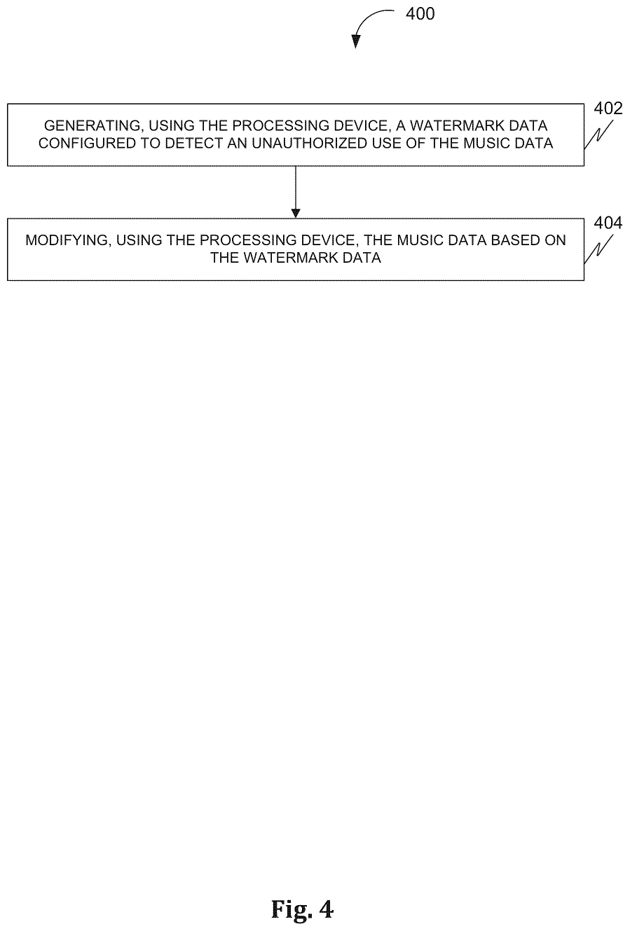

FIG. 4 illustrates a flowchart of a method 400 of facilitating music production including modifying, using the processing device 1104, the music data, in accordance with some embodiments.

Further, in some embodiments, the method 400 may include a step 402 of generating, using the processing device 1104, a watermark data which may be configured to detect an unauthorized use of the music data.

In some embodiments, the watermark data may be detectible by an authorized device.

Further, in some embodiments, the method 400 may include a step 404 of modifying, using the processing device 1104, the music data based on the watermark data.

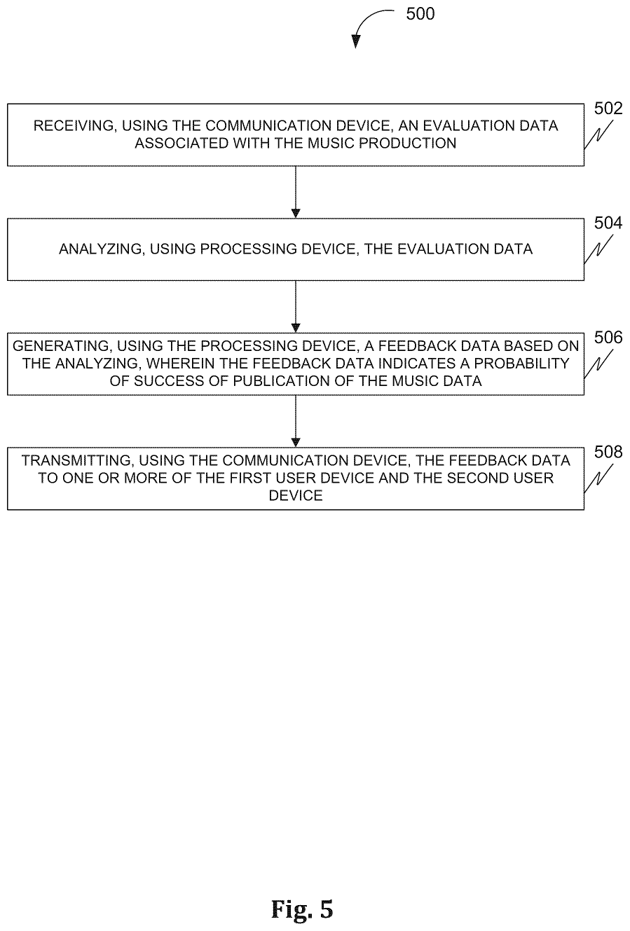

FIG. 5 illustrates a flowchart of a method 500 of facilitating music production including generating, using the processing device 1104, a feedback data, in accordance with some embodiments.

Further, in some embodiments, the method 500 further may include a step 502 of receiving, using the communication device 1102, an evaluation data associated with the music production.

In some embodiments, the evaluation data includes an internal database data, a social media data, and a music trend data.

Further, in some embodiments, the method 500 may include a step 504 of analyzing, using the processing device 1104, the evaluation data. Further, in some embodiments, the method 500 may include a step 506 of generating, using the processing device 1104, a feedback data based on the analyzing. Further, the feedback data indicates a probability of success of publication of the music data. Further, in some embodiments, the method 500 may include a step 508 of transmitting, using the communication device 1102, the feedback data to one or more of the first user device and the second user device.

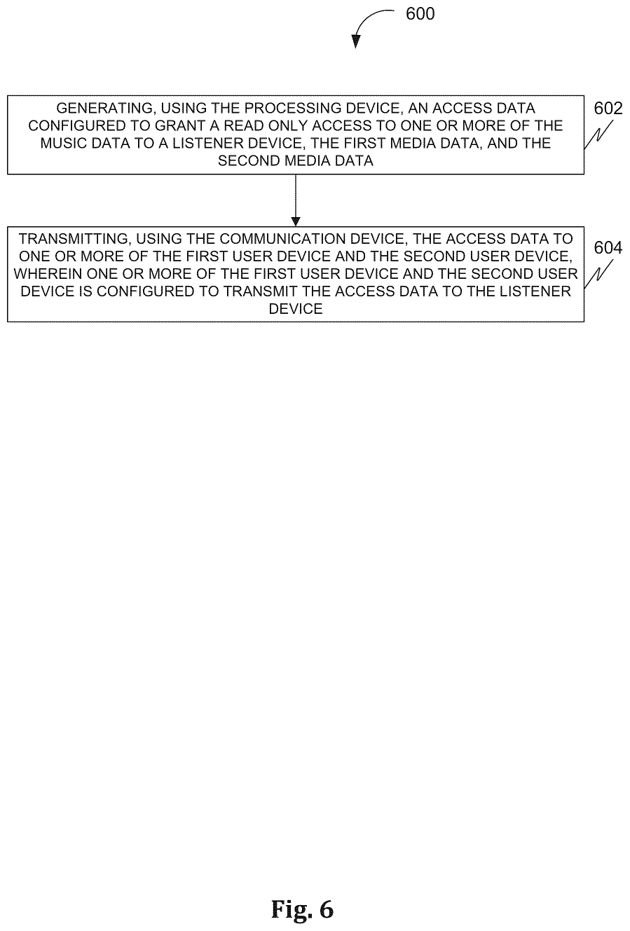

FIG. 6 illustrates a flowchart of a method 600 of facilitating music production including generating, using the processing device 1104, an access data configured to grant a read-only access to one or more of the music data to a listener device, the first media data, and the second media data, in accordance with some embodiments.

Further, in some embodiments, the method 600 further may include a step 602 of generating, using the processing device 1104, an access data which may be configured to grant a read only access to a listener device to one or more of the music data the first media data, and the second media data.

In some embodiments, the listener device includes one or more of a computing device, a smart device and a portable computing device. In some embodiments, the access data includes a temporary link. In some embodiments, the access data includes a URL. In some embodiments, the access data may be valid for a fixed number of plays corresponding to the music data.

Further, in some embodiments, the method 600 may include a step 604 of transmitting, using the communication device 1102, the access data to one or more of the first user device and the second user device. Further, one or more of the first user device and the second user device may be configured to transmit the access data to the listener device.

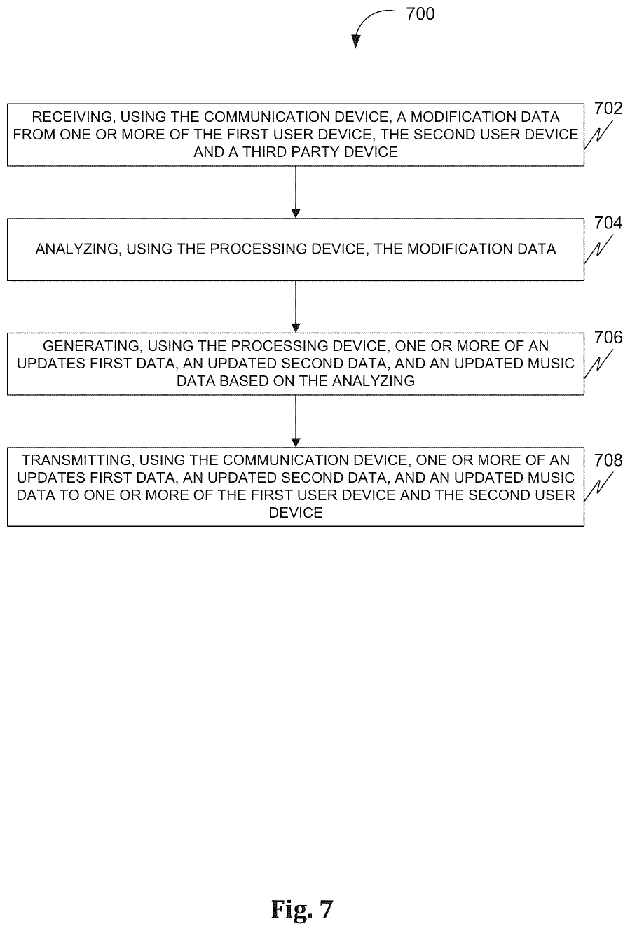

FIG. 7 illustrates a flowchart of a method 700 of facilitating music production including generating, using the processing device 1104, one or more of an updated first data, an updated second data, and an updated music data, in accordance with some embodiments.

Further, in some embodiments, the method 700 may include a step 702 of receiving, using the communication device 1102, a modification data from one or more of the first user device, the second user device, and a third party device. Further, in some embodiments, the method 700 further may include a step 704 of analyzing, using the processing device 1104, the modification data. Further, in some embodiments, the method 700 further may include a step 706 of generating, using the processing device 1104, one or more of an updated first data, an updated second data, and an updated music data based on the analyzing. Further, in some embodiments, the method 700 further may include a step 708 of transmitting, using the communication device 1102, one or more of an updated first data, an updated second data, and an updated music data to one or more of the first user device and the second user device.

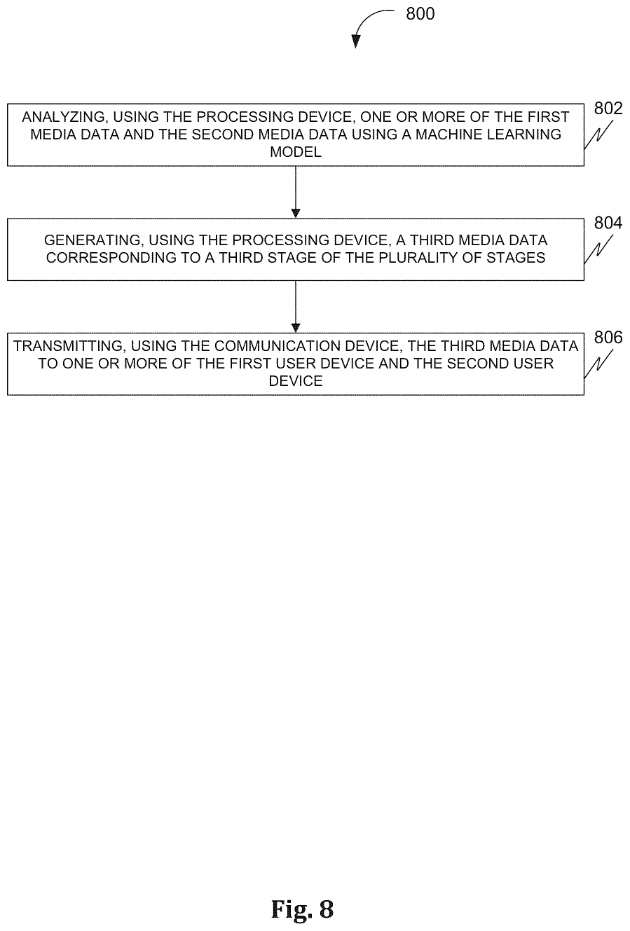

FIG. 8 illustrates a flowchart of a method 800 of facilitating music production including generating, using the processing device 1104, a third media data corresponding to a third stage of the plurality of stages, in accordance with some embodiments.

Further, in some embodiments, the method 800 further may include a step 802 of analyzing, using the processing device 1104, one or more of the first media data and the second media data using a machine learning model. Further, in some embodiments, the method 800 further may include a step 804 of generating, using the processing device 1104, a third media data corresponding to a third stage of the two or more stages. Further, in some embodiments, the method 800 further may include a step 806 of transmitting, using the communication device 1102, the third media data to one or more of the first user device and the second user device.

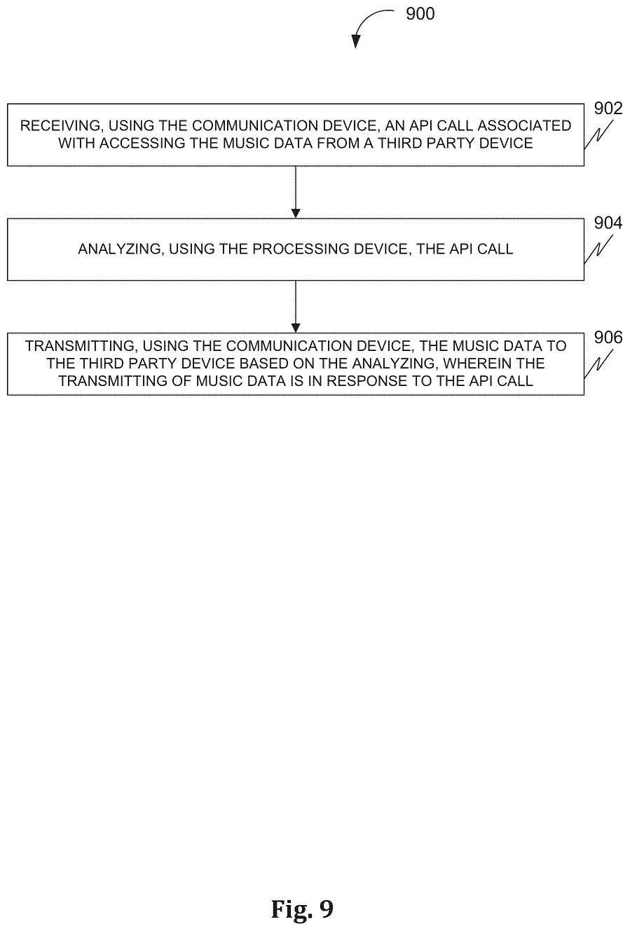

FIG. 9 illustrates a flowchart of a method 900 of facilitating music production including analyzing, using the processing device 1104, the API call, in accordance with some embodiments.

Further, in some embodiments, the method 900 further may include a step 902 of receiving, using the communication device 1102, an API call associated with accessing the music data from a third party device. Further, in some embodiments, the method 900 further may include a step 904 of analyzing, using the processing device 1104, the API call. Further, in some embodiments, the method 900 further may include a step 906 of transmitting, using the communication device 1102, the music data to the third party device based on the analyzing. Further, the transmitting of music data may be in response to the API call.

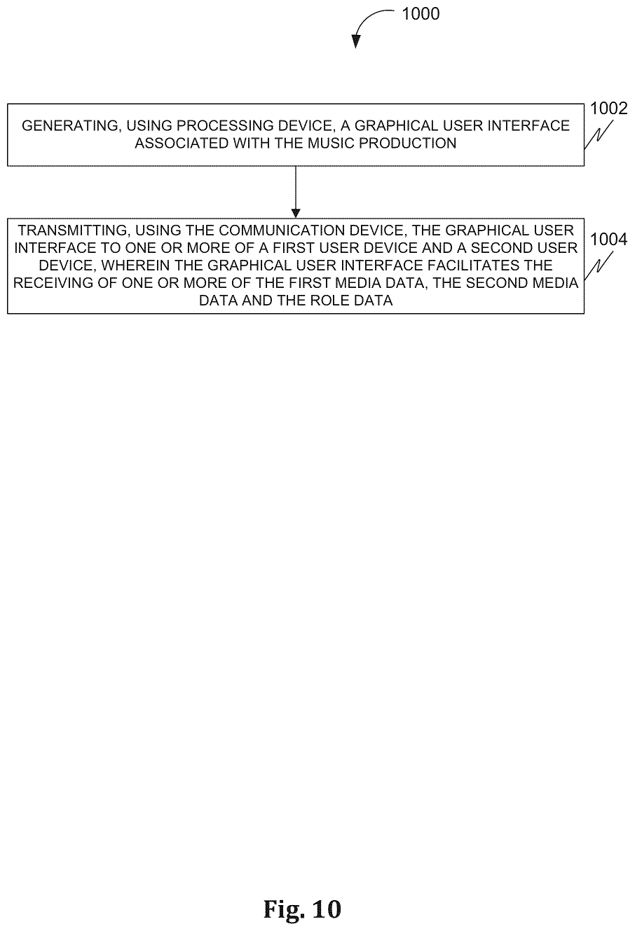

FIG. 10 illustrates a flowchart of a method 1000 of facilitating music production including generating, using the processing device, a graphical user interface associated with the music production, in accordance with some embodiments.

Further, in some embodiments, the method 1000 further may include a step 1002 of generating, using the processing device 1104, a graphical user interface associated with the music production.

In some embodiments, the graphical user interface includes two or more options comprising of a login option, a signup option, a project option, and a my team option.

Further, in some embodiments, the method 1000 further may include a step 1004 of transmitting, using the communication device 1102, the graphical user interface to one or more of a first user device and a second user device. Further, the graphical user interface facilitates the receiving of one or more of the first media data, the second media data, and the role data.

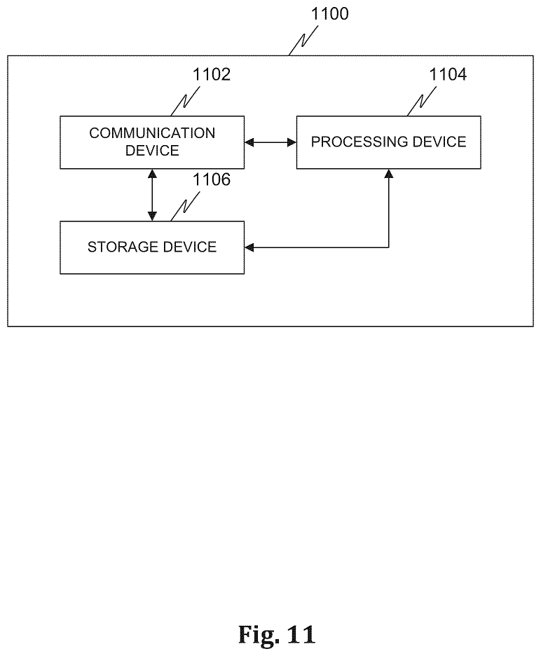

FIG. 11 illustrates a block diagram of a system 1100 of facilitating music production, in accordance with some embodiments.

Accordingly, the system 1100 may include a communication device 1102. Further, the communication device 1102 may be configured to receive a first media data from a first user device associated with a first user. Further, the first media data corresponds to a first stage of two or more stages corresponding to the music production. Further, the communication device 1102 may be configured to receive a second media data from a second user device associated with a second user. Further, the second media data corresponds to a second stage of two or more stages corresponding to the music production. Further, the communication device 1102 may be configured to receive a first role data from the first user device. Further, the first role data indicates a first type of access for the first user device. Further, the communication device 1102 may be configured to receive a second role data from the second user device. Further, the second role data indicates a second type of access for the second user device. Further, the communication device 1102 may be configured to transmit a music data to each of the first user device and the second user device. Further, the system 1100 may include a processing device 1104 communicatively coupled with the communication device 1102. Further, the processing device 1104 may be configured to validate each of the first media data and the second media data based on the first role data and the second role data respectively. Further, the processing device 1104 may be configured to generate the music data based on each of the first media data and the second media data. Further, the generating may be further based on the validating. Further, the system 1100 may include a storage device 1106 communicatively coupled with each of the processing device 1104 and the communication device 1102. Further, the storage may be configured to store the music data in association with one or more of the first user and the second user.

Further, in some embodiments, the processing device 1104 may be further configured to generate a watermark data which may be configured to detect an unauthorized use of the music data. Further, the processing device 1104 may be further configured to modify the music data based on the watermark data.

In some embodiments, the music data may be stored in a hierarchical data structure comprising of two or more music data. Further, each of the two or more music data includes an index data which may be configured to allow accessing of a corresponding music data within the hierarchical data structure.

Further, in some embodiments, the communication device 1102 may be further configured to receive an evaluation data associated with the music production. Further, the processing device 1104 may be further configured to analyze the evaluation data. Further, the processing device 1104 may be further configured to generate a recommendation data based on the analyzing. Further, the recommendation data indicates a probability of success of publication of music data. Further, the communication device 1102 may be further configured to transmit the recommendation data to one or more of the first user device and the second user device.

In some embodiments, the processing device 1104 may be further configured to generate an access data which may be configured to grant a read-only access to a listener device to one or more of the music data, the first media data, and the second media data. Further, the communication device 1102 may be further configured to transmit the access data to one or more of the first user device and the second user device. Further, one or more of the first user device and the second user device may be configured to transmit the access data to the listener device.

Further, in some embodiments, the communication device 1102 may be further configured to receive a modification data from one or more of the first user device, the second user device, and a third party device. Further, the processing device 1104 may be further configured to analyze the modification data. Further, the processing device 1104 may be further configured to generate one or more of an updated first data, an updated second data, and an updated music data based on the analyzing. Further, the communication device 1102 may be further configured to transmit one or more of an updated first data, an updated second data, and an updated music data to one or more of the first user device and the second user device.

Further, in some embodiments, the processing device 1104 may be further configured to analyze one or more of the first media data and the second media data using a machine learning model. Further, the processing device 1104 may be further configured to generate a third media data corresponding to a third stage of the two or more stages. Further, the generation of the music data may be further based on the third media.

In some embodiments, the receiving of one or more of the first media data and the second media data may be facilitated by a musical instrument digital interface (MIDI) device.

Further, in some embodiments, the communication device 1102 may be further configured to receive an API call associated with accessing the music data from a third party device. Further, the processing device 1104 may be further configured to analyze the API call. Further, the communication device 1102 may be further configured to transmit one or more of the first media data, the second media data, and the music data to the third party device based on the analyzing. Further, the transmitting of music data may be in response to the API call.

In some embodiments, the processing device 1104 may be further configured to generate a graphical user interface associated with the music production. Further, the communication device 1102 may be further configured to transmit the graphical user interface to one or more of a first user device and a second user device. Further, the graphical user interface facilitates the receiving of one or more of the first media data, the second media data, and the role data.

Although the invention has been explained in relation to its preferred embodiment, it is to be understood that many other possible modifications and variations can be made without departing from the spirit and scope of the invention as hereinafter claimed.

What is claimed is:

1. A method of facilitating music production, the method comprising:
receiving, using a communication device, a first media data from a first user device associated with a first user, wherein the first media data corresponds to a first stage of a plurality of stages corresponding to the music production;
receiving, using the communication device, a second media data from a second user device associated with a second user, wherein the second media data corresponds to a second stage of the plurality of stages corresponding to the music production;
receiving, using the communication device, a first role data from the first user device, wherein the first role data indicates a first type of access for the first user device;
receiving, using the communication device, a second role data from the second user device, wherein the second role data indicates a second type of access for the second user device;
validating, using a processing device, each of the first media data and the second media data based on the first role data and the second role data respectively;
generating, using the processing device, a music data based on each of the first media data and the second media data, wherein the generating is further based on the validating;
storing, using a storage device, the music data in association with at least one of the first user and the second user; and
transmitting, using the communication device, the music data to each of the first user device and the second user device.

2. The method of claim 1 further comprising:
generating, using the processing device, a watermark data configured to detect an unauthorized use of the music data; and
modifying, using the processing device, the music data based on the watermark data.

3. The method of claim 1, wherein the music data is stored in a hierarchical data structure comprising of a plurality of music data, wherein each of the plurality of music data comprises an index data configured to allow accessing of a corresponding music data within the hierarchical data structure.

4. The method of claim 1 further comprising:
receiving, using the communication device, an evaluation data associated with the music production;
analyzing, using processing device, the evaluation data;
generating, using the processing device, a feedback data based on the analyzing, wherein the feedback data indicates a probability of success of publication of the music data;
transmitting, using the communication device, the feedback data to one or more of the first user device and the second user device.

5. The method of claim 1 further comprising:
generating, using the processing device, an access data configured to grant a read only access to a listener device to one or more of the music data, the first media data, and the second media data; and
transmitting, using the communication device, the access data to one or more of the first user device and the second user device, wherein one or more of the first user device and the second user device is configured to transmit the access data to the listener device.

6. The method of claim 1 further comprising:
receiving, using the communication device, a modification data from one or more of the first user device, the second user device, and a third party device;
analyzing, using the processing device, the modification data;
generating, using the processing device, one or more of an updated first data, an updated second data, and an updated music data based on the analyzing;
transmitting, using the communication device, one or more of an updated first data, an updated second data, and an updated music data to one or more of the first user device and the second user device.

7. The method of claim 1 further comprising:
analyzing, using the processing device, one or more of the first media data and the second media data using a machine learning model;
generating, using the processing device, a third media data corresponding to a third stage of the plurality of stages;
transmitting, using the communication device, the third media data to one or more of the first user device and the second user device.

8. The method of claim 1, wherein the receiving of one or more of the first media data and the second media data is facilitated by a musical instrument digital interface (MIDI) device.

9. The method of claim 1 further comprising:
receiving, using the communication device, an API call associated with accessing the music data from a third party device;
analyzing, using the processing device, the API call;
transmitting, using the communication device, the music data to the third party device based on the analyzing, wherein the transmitting of music data is in response to the API call.

10. The method of claim 1 further comprising:
generating, using the processing device, a graphical user interface associated with the music production;
transmitting, using the communication device, the graphical user interface to one or more of a first user device and a second user device, wherein the graphical user interface facilitates the receiving of one or more of the first media data, the second media data and the role data.

11. A system for facilitating music production, the system comprising:
a communication device configured to:
receive a first media data from a first user device associated with a first user, wherein the first media data corresponds to a first stage of a plurality of stages corresponding to the music production;
receive a second media data from a second user device associated with a second user, wherein the second media data corresponds to a second stage of a plurality of stages corresponding to the music production;
receive a first role data from the first user device, wherein the first role data indicates a first type of access for the first user device;
receive a second role data from the second user device, wherein the second role data indicates a second type of access for the second user device;
transmit a music data to each of the first user device and the second user device;
a processing device communicatively coupled with the communication device, wherein the processing device is configured to:
validate each of the first media data and the second media data based on the first role data and the second role data respectively;
generate the music data based on each of the first media data and the second media data, wherein the generating is further based on the validating;
a storage device communicatively coupled with each of the processing device and the communication device, wherein the storage is configured to:
store the music data in association with at least one of the first user and the second user.

12. The system of claim 11, wherein the processing device is further configured to:
generate a watermark data configured to detect an unauthorized use of the music data; and
modify the music data based on the watermark data.

13. The system of claim 11, wherein the music data is stored in a hierarchical data structure comprising of a plurality of music data, wherein each of the plurality of music data comprises an index data configured to allow accessing of a corresponding music data within the hierarchical data structure.

14. The system of claim 11, wherein the communication device is further configured to receive an evaluation data associated with the music production, wherein the processing device is further configured to:
analyze the evaluation data;
generate a recommendation data based on the analyzing, wherein the recommendation data indicates a probability of success of publication of music data, wherein the communication device is further configured to transmit the recommendation data to one or more of the first user device and the second user device.

15. The system of claim 11, wherein the processing device is further configured to generate an access data configured to grant a read only access to a listener device to one or more of the music data, the first media data, and the second media data, wherein the communication device is further configured to transmit the access data to one or more of the first user device and the second user device, wherein one or more of the first user device and the second user device is configured to transmit the access data to the listener device.

16. The system of claim 11, wherein the communication device is further configured to receive a modification data from one or more of the first user device, the second user device, and a third party device, wherein the processing device is further configured to:
analyze the modification data;
generate one or more of an updated first data, an updated second data, and an updated music data based on the analyzing, wherein the communication device is further configured to transmit one or more of an updated first data, an updated second data, and an updated music data to one or more of the first user device and the second user device.

17. The system of claim 11, wherein the processing device is further configured to:
analyze one or more of the first media data and the second media data using a machine learning model;
generate a third media data corresponding to a third stage of the plurality of stages, wherein the generation of the music data is further based on the third media.

18. The system of claim 11, wherein the receiving of one or more of the first media data and the second media data is facilitated by a musical instrument digital interface (MIDI) device.

19. The system of claim 11, wherein the communication device is further configured to:
receive an API call associated with accessing the music data from a third party device, wherein the processing device is further configured to analyze the API call;
transmit one or more of the first media data, the second media data, and the music data to the third party device based on the analyzing, wherein the transmitting of music data is in response to the API call.

20. The system of claim 11, wherein the processing device is further configured to generate a graphical user interface associated with the music production, wherein the communication device is further configured to transmit the graphical user interface to one or more of a first user device and a second user device, wherein the graphical user interface facilitates the receiving of one or more of the first media data, the second media data, and the role data.
